(19) United States
(12) Patent Application Publication
(10) Pub. No.: US 2025/0065646 A1
(43) Pub. Date: Feb. 27, 2025

(54) APPARATUS AND METHOD FOR PRINTING ON LANDSCAPE FABRIC

(71) Applicant: ALEXANDER FRANCIS BETZ, CHESTER, NJ (US)

(72) Inventor: ALEXANDER FRANCIS BETZ, CHESTER, NJ (US)

(21) Appl. No.: 18/236,981

(22) Filed: Aug. 23, 2023

(51) Int. Cl. B41J 3/407; A01G 13/02; B41J 11/00; D06P 1/44; D06P 5/24

(52) U.S. Cl. CPC B41J 3/4078; A01G 13/0268; B41J 11/00214; B41J 11/0085; D06P 1/44; D06P 5/008

(57) ABSTRACT

A method which includes printing indicia on landscape fabric using a roll-to-roll printer; and wherein the landscape fabric is configured to have a plurality of characteristics based on the printing requirements of the roll-to-roll printer. The roll-to-roll printer may be a hybrid printer, which suctions the landscape fabric; and wherein the hybrid printer is configured to print on flexible media and rigid media. The plurality of characteristics of the landscape fabric may include a weight per square foot of the landscape fabric; and wherein the weight per square foot of the landscape fabric is great enough to hold the landscape fabric in place by the roll-to-roll printer. The plurality of characteristics of the landscape fabric may include that the landscape fabric has been cut from a sheet which is larger than the landscape fabric in a manner so that at least one edge of the landscape fabric is uniform.

### FIELD OF THE INVENTION

This invention relates to methods and apparatus for printing on landscape fabric.

### BACKGROUND OF THE INVENTION

Landscape fabric is known in the art and may be used as a template for planting, and/or to block undesirable weeds, while allowing the flow of water and nutrients to plants, such as shown for example, in U.S. Pat. Nos. 11,297,780 and 11,641,813, to inventor Alexander Betz, both of which are incorporated by reference herein.

The above patents disclose printing identifying information on landscape fabric. However, there are various challenges to printing on landscape fabric, which are not satisfactorily resolved by the above patents.

### SUMMARY OF THE INVENTION

In at least one embodiment, the present invention resolves various challenges to printing on landscape fabric to provide better landscape fabric which has identifying information for planting and/or which is used to block undesirable weeds. The landscape fabric provided also preferably prevents soil compaction and erosion of planting beds. In at least one embodiment, the landscape fabric also helps to prevent erosion by stopping heavy rains from washing away the soil underneath. In addition, more specifically for vegetable and garden flower beds but also applicable to landscape beds, the improved landscape fabric creates an additional layer of protection that prevents soil compaction which can negatively affect the plants roots by preventing proper airflow over time to allow nutrients and water flow to desirable plants.

In at least one embodiment, a method is provided including the step of: printing indicia on landscape fabric using a roll-to-roll printer; and wherein the landscape fabric is configured to have a plurality of characteristics based on the printing requirements of the roll-to-roll printer.

In at least one embodiment, the roll-to-roll printer may be a hybrid printer, which uses a suction bed to configured to suction the landscape fabric; and wherein the hybrid printer is configured to print on box flexible media and rigid media.

In at least one embodiment the plurality of characteristics of the landscape fabric include a weight per square foot of the landscape fabric; and wherein the weight per square foot of the landscape fabric is great enough to hold the landscape fabric in place by the roll-to-roll printer.

In at least one embodiment, the plurality of characteristics of the landscape fabric include that the landscape fabric has been cut from a sheet which is larger than the landscape fabric in a manner so that at least one edge of the landscape fabric is uniform.

In at least one embodiment, the plurality of characteristics of the landscape fabric include that the landscape fabric has been hemmed from a sheet which is larger than the landscape fabric in a manner so that at least one edge of the landscape fabric is uniform.

In at least one embodiment of the present invention, the plurality of characteristics of the landscape fabric include a thickness, which includes a plurality of fibers that are part of the landscape fabric, and wherein the thickness of the landscape fabric is one millimeter or less.

The landscape fabric may be a non-woven landscape fabric or a woven landscape fabric.

The method may further include printing indicia on landscape fabric; wherein the landscape fabric is biodegradable paper; and wherein the indicia is printed using ink made of algae.

A method is also provided which includes adjusting the viscosity of an agricultural dye to form a modified agricultural dye having a viscosity of between 6,000 and 10,000 centipoises; printing indicia on landscape fabric using ink made of the modified agricultural dye; and wherein the landscape fabric is biodegradable paper.

In at least one embodiment, the indici printed on the landscape fabric show one or more closed shapes, with an alphanumeric character within each of the one or more close shapes, and the method may be further comprised of providing further information matching up each alphanumeric character with a particular plant.

The further information may match up each alphanumeric character with at least one material that is used with the particular plant for planting the particular plant.

In at least one embodiment, the one or more closed shapes identifies planting location and wherein an additional landscaping requirement is provided on a card for each planting location of each of the one or more closed shapes.

In at least one embodiment, the printing indicia includes a closed curve planting bed outline.

The landscape fabric may be comprised of two sections which are configured to overlap to cause the printing indicia to define a closed curved planting bed outline.

### BRIEF DESCRIPTION OF THE DRAWINGS

FIG. 1 shows a scaled diagram that is typically provided in a pdf (portable document format) document in a computer memory of FIG. 7;

FIG. 2 shows a top view of a diagram of a scaled vector file which may be stored in the computer memory of FIG. 7;

FIG. 3A shows the landscape fabric of FIG. 2, with two sections laid together, with overlap of the two sections laid on top of a section or plot of land;

FIG. 3B shows the landscape fabric of FIG. 2 modified by cutting holes where numbered designations were located, and located on the plot of land;

FIG. 4 shows a large landscape fabric sheet, from which the landscape fabric of FIGS. 3A and 3B may be cut;

FIG. 5 is a simplified diagram of a UV (ultraviolet light) printer, and a substrate passing through the printer;

FIG. 6 shows a roll of landscape fabric;

FIG. 7 shows a simplified block diagram of a computer apparatus for use with the present invention;

FIG. 8 shows a simplified diagram of a hybrid printer with suction bed for use in accordance with an embodiment of the present invention;

FIG. 9 shows a simplified diagram of a tree tied to a plurality of stakes;

FIG. 10 shows a simplified diagram of an online interface with associated plant information;

FIG. 11 shows a simplified plant card associated to maps;

FIG. 12 shows a tomato plant within a cage;

FIG. 13 shows an internet web application or software application interface to assign plants with visuals; and

FIG. 14 shows a computer apparatus for use in accordance with an embodiment of the present invention.

### DETAILED DESCRIPTION OF THE DRAWINGS

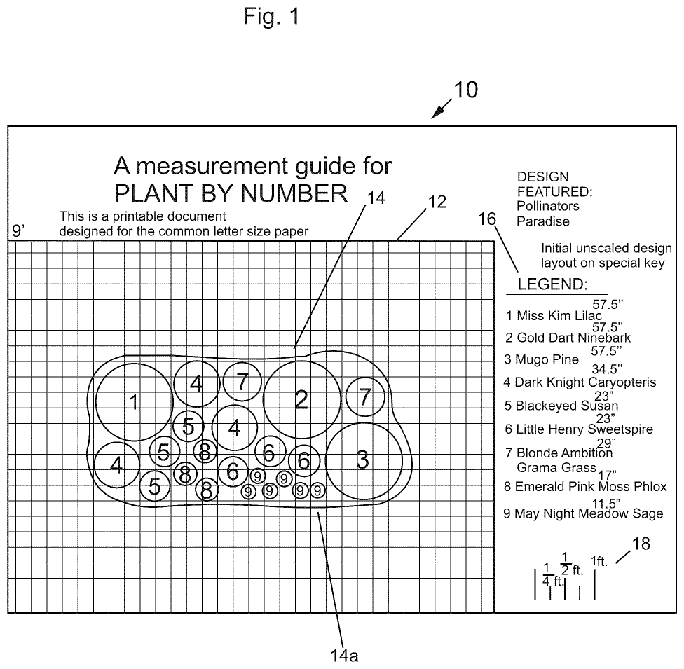

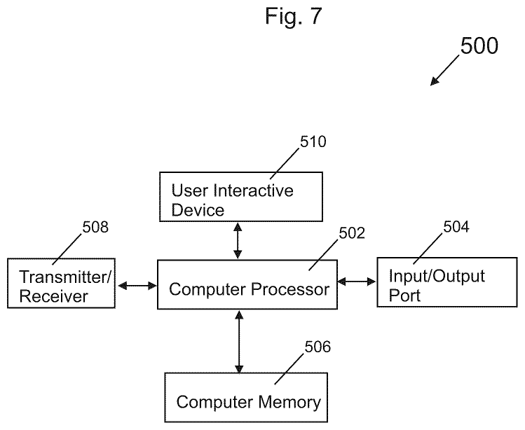

FIG. 1 shows a scaled diagram 10 that is typically provided in PDF (portable document format) format that accompanies one or more landscape fabric prints in accordance with an embodiment of the present invention. The scaled diagram 10 in pdf format is typically stored in computer memory, such as computer memory 506 of the apparatus 500 shown in FIG. 7.

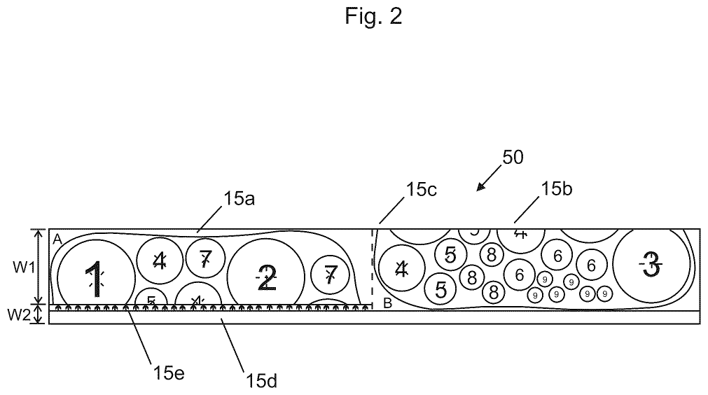

The scaled diagram 10 of the pdf document stored in computer memory 506 is configured to be printed out on a single sheet of paper, which may be for example, 8.5 inches by 11.0 inches. The pdf document for the scaled diagram 10, in at least one embodiment, is a separate item that can be purchased as a digital download, such as from computer processor 502 and/or computer memory 506, through transmitter/receiver 508 and/or input/output port 504, without a landscape fabric. The scale diagram 10 of the pdf document is a version of a scaled landscape diagram which may correspond to a printed landscape fabric 10′ shown in FIG. 1A. The scaled diagram 10, which is typically a pdf file stored in computer memory 506 includes a grid 12, a planting diagram 14, a legend 16, and scale information 18. In at least one embodiment, the grid 12 will not be present when a particular landscape fabric has the planting diagram 14 printed on it. Generally, only the diagram 50 of FIG. 2 is printed on landscape fabric, in accordance with an embodiment of the present invention. Generally, that includes the planting regions or circles with the corresponding inside numbers, The 6.0 inch in width W2, overlap key 15e. The overlap key 15e, shows arrows point up to illustrate where to slide the material and the direction. Sections 15a and 15b, may be marked with “A” and “B” designations, respectively, that help the customer know in which order to lay the sections 15a and 15b down. The designation “A” is shown in the upper lefthand corner of section 15a, while the designation “B” is shown in a lower lefthand corner of section 15b. Some larger designs that are over 9.5 feet in width (5.0 foot of material, 6.0 inches of overlap 15d, max 9.5-foot width for W1+W2 width). As an example, a fourteen-foot-wide design would have four sections printed concurrently labeled with designations “A”, “B” and “C”.

The planting diagram 14 includes a planting bed outline or perimeter 14a, in which is enclosed a plurality of planting circles. Each of the plurality of planting circles has a printed number inside of it, indicating a particular plant shown in the legend 16.

The location identifiers, in this case the numbers, within the planting circles laid down combination of sections 15a and 15b, identify a plurality of plants categories of plants and or hardscaping elements or fertilizers, in at least one embodiment of the invention individual plants are not specifically assigned to each location. These customizable layouts can be, but not always, be assigned values to a wide variety of corresponding plants and hardscape elements that fit each location. It is important to note, in one or more embodiments of the present invention, that one identifying number may also identify the location of two separate inputs. For example, would be location 1, in the associated key also include the type of fertilizer, or if it's a large tree that requires staking and tying. In the case of vegetable gardens, location 1 could identify the placement of a tomato plant and the tomato cage. But items being labeled under the same number as these are additional features that would either need to be or could potentially be included in the design. The plurality of plants and features could then be customized through a computer/app interface.

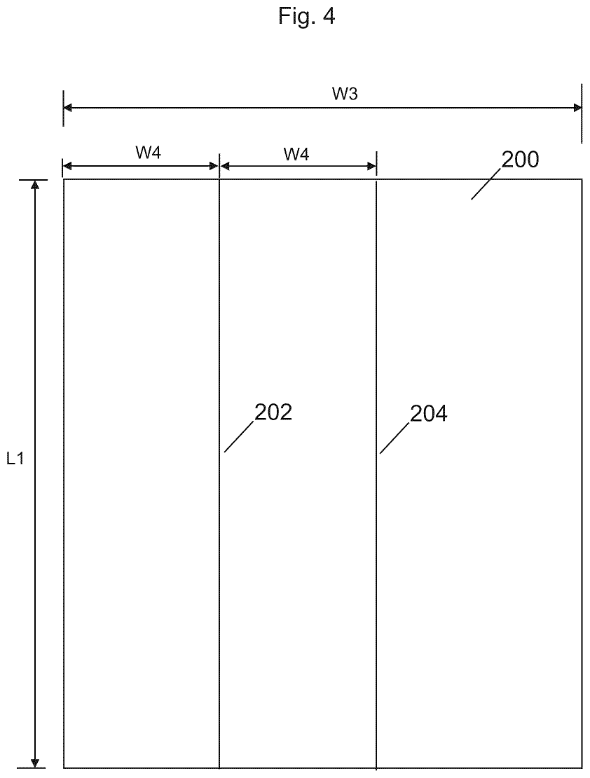

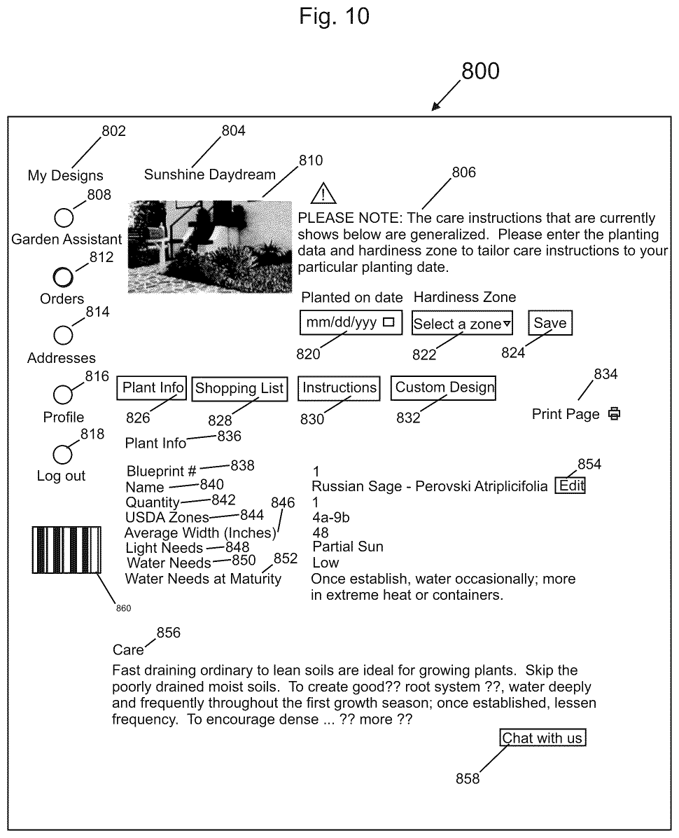

The plant interface 800, shown in FIG. 10, which may be provided online on a computer display, such as computer display 1204 of FIG. 4 or in a store as a physical card or on a piece of paper, creates a visual representation of a plant arrangement, shown in photograph 810, at various stages of its development cycle in terms of size and colors attributed to each season. This is achieved in at least one embodiment through a bar code, such as code 860 located on the interface 800 (such as on the computer display 1204, or on a physical card such as a piece of paper, shown in FIG. 10 or in another embodiment with a specific plant identifier tag or with a QR code or bar code for code 860, or an RFID (radio frequency identification) tag for code 860. Enabling the customer to design as they go in a retail setting while seeing the design, based on the customizable layout, come to life.

In at least one embodiment, the plant interface 800 may be referred to as an online dashboard that associates a plurality of plants, which may be all of the plants provided, to the particular products or particular landscaping designs. Once a particular landscaping design or product is purchased this plant interface 800 is made available to the customer, such as through a password and the interface 800 details the plants and all of the information for a particular design.

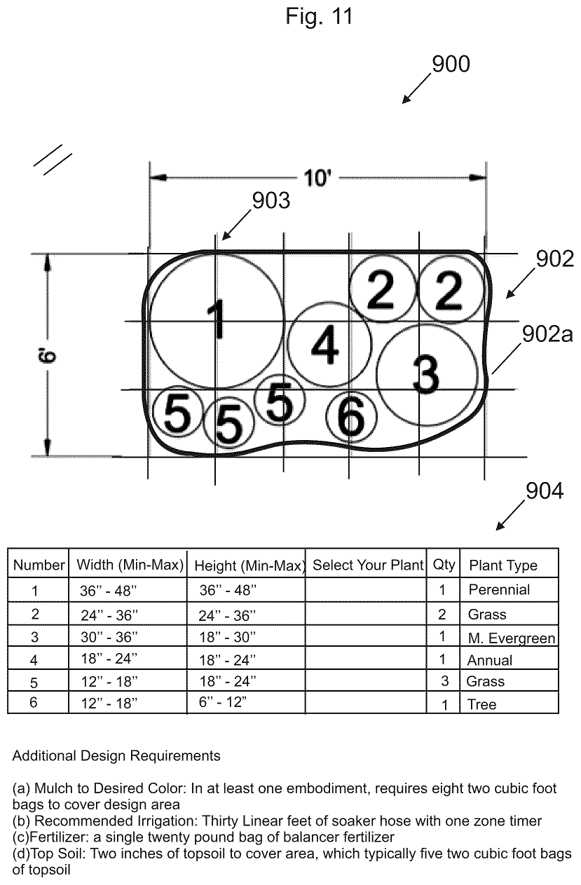

FIG. 11 shows a basic printed design card 900. A customer can take the design card 900 into a store and fill out the plants needed, on the lines of the table 904. In this case plants “1”, “2”, “3”, “4”, “5”, and “6” in the table can be identified with names of plants on the corresponding row under “Select your Plant” column in table 904. The design card 900 can be a physical card and the customer may fill in plants under “Select your Plant” column in pen, for example, or the design card 900 may be an internet page, displayed on the computer display 1204 and a customer may enter plants under “Select your plant” column by use of computer interactive device 1202, such as a keyboard, mouse, and/or touch screen. Table 904 may include a column “Plant type”, which in this example, indicates “Perennial”, “Grass”, “M. Evergreen”, “Annual”, “Grass”, and “Tree” for the rows numbered “1”, “2”, “3”, “4”, “5”, and “6” respectively.

The quantities of the plants under column “Qty” in table 904 may also be entered by a customer. In this example, the quantities correspond to the number of planting circles or regions with the particular number designations shown in planting diagram or planting map 902. The map 902 may include a closed shape outline 902a in which is located a plurality of planting circles with a number or alphanumeric inside each one of the planting circles. For example, there is one plant circle with the number “1”, the quantity is shown as “1” in the table 904 for the row number “1”.

The design card 900 may also display information about the design (or the map 902, including the plant circles and number designations) and other accompaniments for the whole design including top soil, fertilizer, mulch calculations to fill the design. For example, as shown in FIG. 11, the design card 900 may include “Additional Design Requirements” “(a)”, “(b)”, “(c)”, and “(d)”. The additional design requirement “(a)” may indicate that the number of two cubic foot bags of mulch to cover the design area, such as area of outline 902a, is eight bags in at least one embodiment, The additional design requirement “(b)” may indicate that the recommended irrigation is thirty linear feet of soaker hose (i.e. hose with perforations to allow water to come through and irrigate), with a one zone timer. The additional design requirement “(c)” may indicate that the amount of fertilizer required for the design within the outline 902a is a single twenty pound bag of balancer fertilizer. The additional design requirement “(d)” may indicate that two inches of topsoil are needed to cover the area of outline 902, such as a certain number of two cubic foot bags of topsoil, which may be five bags.

In at least one embodiment, a customer goes into a physical store with a design card 900. The customer would look at location “1” of the design card 900 which calls for “1” perennial with a minimum mature spread of thirty-six inches and a maximum mature spread of forty-eight inches, and then the customer would go to the perennial section of the physical store. The customer would then look at or examine the plant cards that come in every pot, the plant tags or cards or identifications that are at any typical garden center in every plant to identify the plant and its characteristics. The customer would then find a perennial plant that fits the requirements of the design card 900 and put that perennial plant in their basket to purchase from the physical store.

The above steps would then be repeated for location “2” of the design card 900, which in FIG. 11 requires a “grass” plant type.

In at least one embodiment of the present invention, the design card 900 and related information this is done through a computer software application program, stored in computer memory 210 and implemented by computer processor 1206 to display information on computer display 1204.

The plurality of planting circles includes: one planting circle with printed number “1”, one planting circle with printed number “2”, one planting circle with printed number “3”, three planting circles with printed number “4”, three planting circles with printed number “5”, three planting circles with printed number “6”, two planting circles with printed number “7”, three planting circles with printed number “8”, and six planting circles with printed number “9”.

As shown in the Legend 16, printed number “1” specifies a “Miss Kim Lilac” plant which typically has a full growth radius of 57.5 inches; the printed number “2” specifies a “Gold Dart Ninebark” plant which typically has a full growth radius of 57.5 inches, the printed number “3” specifies a “Mugo Pine” plant which typically has a full growth radius of 57.5 inches, the printed number “4” specifies a “Dark Knight Caryopteris” plant which typically has a full growth radius of 34.5 inches; the printed number “5” specifies a “Blackeyed Susan” plant which typically has a full growth radius of 23.0 inches; the printed number “6” specifies a “Little Henry Sweetspire” plant which typically has a full growth radius of 23.0 inches; the printed number “7” specifies a “Blonde Ambition Grama Grass” plant which typically has a full growth radius of 29.0 inches; the printed number “8” specifies an “Emerald Pink Moss Phlox” plant which has a full growth radius of 17.0 inches; and the printed number “9” specifies a “May Night Meadow Sage” plant which has a full growth radius of 11.5 inches. The information for each of the plants “1”-“9” shown under or in the Legend 16 is typically printed on the fabric 10 and/or stored in a computer memory 506. The planting diagram 10 can be considered to be a key that comes with every landscape print on paper, and/or can be printed out from computer memory 506. The locations of the planting circles and the plants that fill them are also provided in the under dashboard of the customer that can be referenced online, as shown in FIG. 11.

FIG. 2 shows a top view of a diagram 50 of a scaled vector file which may be stored in computer memory 506. The scale vector file, which includes diagram 50, is a file which is used to print on the landscape fabric to create a landscape fabric, having the same design as diagram 50 printed on the landscape fabric. In at least one embodiment of the present invention, this is how a landscape design is provided on a landscape fabric to a customer. In at least one embodiment, the diagram 50 in FIG. 2, printed on the landscape fabric would be the exact replica of a printed design on the landscape fabric. It is in two sections, 15a and 15b, with section numbers because the size of the design (width, which would typically be 2×W1, shown in FIG. 2) is larger than the maximum width of the printer's capabilities. In at least one embodiment, the design is cut in half (a 6.0 inch overlap or overlap key for width W2 is inserted), as these fabrics typically require an overlap between adjoining sections so weeds do not grow through them. Typically, in accordance with one embodiment of the present invention, the entire design for diagram 50 in FIG. 2 is printed concurrently. FIG. 2 is a top down view of exactly what the design would look like printed on the landscape fabric. The diagram 50 data is stored in a file in computer memory 506 that is used to enter into the printer to print on landscape fabric.

In at least one embodiment there will only be a grid printed on the landscape fabric and no corresponding circles. Some woven landscape fabric comes with one-foot lines weaved into the material, but not printed on. But this only provides one axis to help align plants and is not sufficient in helping to space the plants. In at least one embodiment, a garden map, such as the garden map 902 shown in FIG. 11, including overall closed outline 902a, horizontal and vertical grid lines 903, planting circles within overall closed shape outline 902a, and alphanumeric designations (such as numbers in FIG. 11) one within each planting circle, are provided that people will be able to create custom layouts for. So in the interface 900 of FIG. 11 a customer can drag and drop planting circles over the grid layout or grid lines 903, then use that as their key and the printed fabric with have the matching spaced foot spaced grid lines, which in FIG. 11, are shown as two feet horizontally and two feet vertically.

FIG. 2 shows portions 15a and 15b, which may be, or may substantially be the top and bottom halves, respectively, of the planting diagram 14 shown in FIG. 1. In FIG. 2, the landscape fabric or diagram 50 includes a plurality of arrows 15e within the overlap key 15d, which are pointing up which tells a customer how to position the two section pieces 15a and 15b. When placing landscape fabric next to each other there should be a 6.0-inch overlap to prevent weeds from growing through this overlap. In at least one embodiment of the present invention, this key is provided to a customer, so that the customer knows how far to overlap the two pieces 15a and 15b.

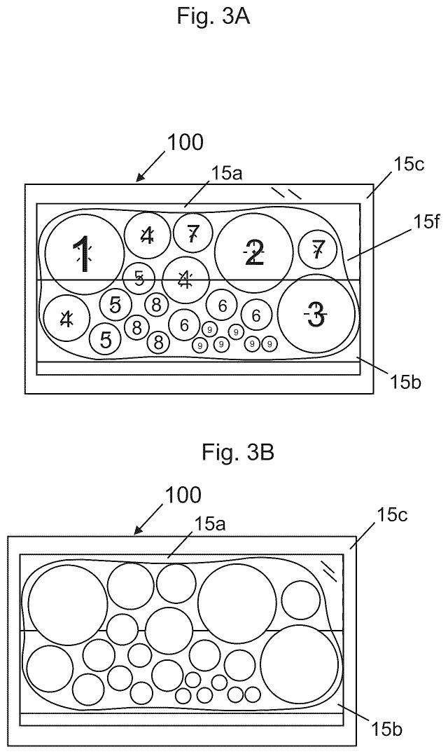

In operation, the two halves, 15a and 15b are separated by cutting along dashed line 15c, and then the two halves are overlapped together to form the complete diagram 14 shown in FIG. 3A.

FIG. 3A shows the landscape fabric or diagram 50 of FIG. 2, with two sections 15a and 15b laid together, with overlap of section with width W2, and laid on top of a section or plot of land 100.

FIG. 3B shows the landscape fabric or diagram 50 of FIG. 2 modified by cutting holes where numbered designations were located. FIG. 2 is the actual print file and how the fabric would be presented to the customer. The customer then cuts the two sections 15a and 15b apart, along the dotted line 15c in FIG. 2. These two sections 15a and 15b are then laid in order that the design matches up to create FIG. 3A.

FIG. 3A shows the landscape fabric with the sections 15a and 15b, overlapping and laid on top of a section or plot of land 100.

FIG. 3B shows the landscape fabric with planning diagram of FIG. 2 modified to modified fabric by cutting out holes where numbered designations were located. Alternatively, an “X” may be cut into the fabric and then the flaps are folded underneath the remaining fabric.

In operation, sections 15a and 15b and the fabric on which they are located are laid over a section or plot of land, such as plot or section 100 show in FIG. 3A, so that diagram shown by the combination of sections 15a and 15b and the fabric it is on covers, lies on top of, comes in contact with, and is parallel or substantially parallel to the section or plot of land 100. While the diagram on the combination of the sections 15a and 15b shown in FIG. 3A and fabric is fixed in place on the section or plot of land 100, such as by spikes, stakes, or landscaping stapes, on the perimeter of outline 15f, the circles are cut out of the fabric, or X's cut, resulting in openings in the fabric where the circles were as shown in FIG. 3B, for the scenario where circles are cut out.

After the openings are cut out or X cuts made and the flaps folded under the combination of modified sections 15a and 15b, as shown in FIG. 3B, a plant or identifying element (such as a birdbath, bird feeder) can be placed through its appropriate opening and into the ground of land 100. The cutting out of a hole in the planting diagram show within outline 15f of FIG. 3A, and fabric can be done one hole at a time, then a hole can be dug through the particular opening in the ground of land 100, and then a plant can be planted in the hole. For example, a hole for number “1” can be cut out of the diagram outline 15f and fabric, then a hole dug into the land 100 through that hole, and then a plant planted into the ground of land 100.

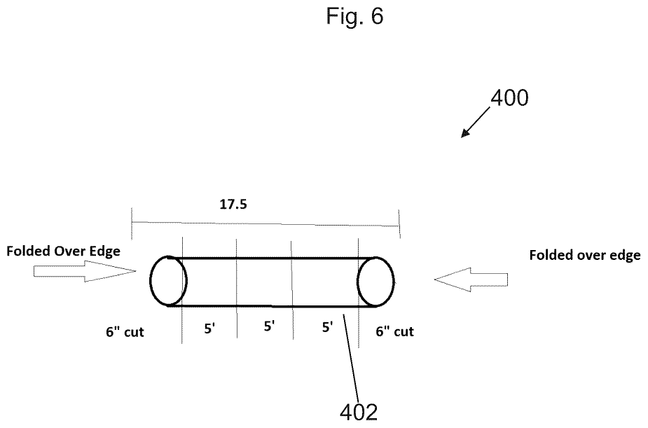

FIG. 4 shows a large landscape fabric sheet, from which the landscape fabric of FIG. 3A and 3B may be cut. FIG. 4 shows the width W3 that landscape fabric is typically produced and then the fabric 200 cut down into smaller sections, such as along lines 202 and 204, for use in the retail industry. In at least one embodiment, W4 in FIG. 4 the same as W1+W2 in FIG. 2. Generally, a cut sheet will have a width W4 shown in FIG. 4, and a length L1 shown in FIG. 4 after it is cut from overall sheet 200. FIG. 4 shows a large landscape fabric sheet 200, from which the landscape fabric portion 11 (on which is located planting diagram 14) of FIG. 2 may be cut. The fabric sheet 200 may have a width W3 of about seventeen feet, and may be cut by heat cuts 202 and 204, so that there are portions of sections having a width W4, which is five feet, and a length of L1, which may be about twenty feet. The fabric sheets may be customer ordered to be cut to any desired specs. But then the customer is typically charged for the waste. So if the fabric sheet 17.5 by 500.0 feet long, and one needs a five foot section to work with printer, the fabric sheet company, will cut three five foot sections from a master roll, but the customer will also be billed for the additional 2.5 feet of wasted fabric that cannot be used. This is especially important with the non-woven fabric as the ends need to be cut off. As shown in FIG. 6, producing to fifteen feet does not work as 3.0-6.0 inches need to be trimmed off which could only produce two 60.0 inch sections and one would be shorter. So we need to produce using large 17.5 foot with about 1 foot cut off (6.0 inches from both sides) and then there is only 1.5 feet of total waste times three hundred or five hundred depending on how big the master roll is.

The biggest challenges to printing on landscape fabric, such as fabric sheet 200 of FIG. 4 or fabric 50 shown in FIG. 2, are the inconsistencies in the fabrics. In accordance with one or more embodiments of the present invention optimum parameters are determined, such as for the weight of the fabric, the manner in which the edges are cut to provide edge consistency, the thickness of the fabric, and the way in which rolls of the fabric are produced.

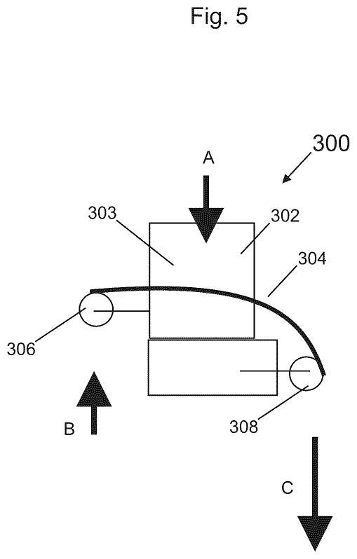

Less expensive roll to roll uv printers, such as UV printer 302 shown in FIG. 5 in simplified form, do not have the ability to artificially adjust the head height to the extent needed to print on the thicker fabrics they can adjust slightly but only allow substrates with a thickness of 1 mm (millimeters) like the expensive hybrid UV printers or the HP r1000 latex printers which can adjust head heights of 2.0 inches or more. Cheaper roll to roll UV printers require a substrate of one mm (millimeter) or less. This will work satisfactorily with the woven fabric with the proper edges or the non woven landscape fabric. However, the 8.0 oz. (ounce) fabric required for the suction beds, for the less expensive roll to roll UV printer, such as printer 302, is too thick. Similarly, the 4.0 oz (ounce) fabric is under one mm, but care has to be taken during the manufacturing process to try and keep it thinner. Even though the 4.0 oz is usually around 0.825 mm, the fibrous hairs that stick up are higher which can start to clog up the print heads on these new UV roll to roll printers, such as printer 302. These printers, such as printer 302, cost about twenty-four thousand dollars. A HP Latex 200 printer costs about $250,000. Hybrid UV printers (which typically have higher head height cost about $115,000k.

FIG. 5 is a simplified diagram 300 of a UV (ultraviolet light) printer 302, a substrate 304 passing through the printer 302, an infeed roller 306, and an outfeed roller 308. The diagram shows direction arrows A, B, and C. The direction, or arrow B refers to the direction that material, such as blank landscape fabric is fed into the infeed roller 306. The direction or arrow C refers to the direction the substrate 304 or landscape fabric after printing, flows outwards over the outfeed roller 308. The arrow A refers to downwards pressure direction on the substrate 304 while printing is taking place in the printer 302.

The UV printer 302 shown in FIG. 5 is not belt fed, in at least one embodiment of the present invention, but relies on the infeed roller 306 and the outfeed roller 308 of the printer 302 to pass the substrate 304 (such as a landscape fabric) through the known printing mechanism 303, within the printer 302. In at least one embodiment, there may also be pincher rollers on the inside of the printer 302. The pincher rollers on the inside of printer 302 are internal rollers that help the substrate 304 feed through the printer 302.

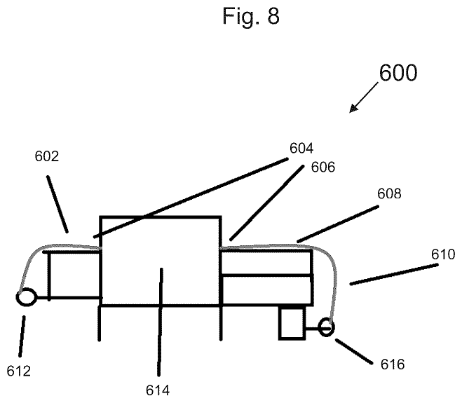

The UV printer 302 shown in FIG. 5, in simplified form, reduces the problems experienced by the HP (Hewlett Packard (trademarked)) latex and UV (ultraviolet hybrid printers which need to suction down the fabric or substrate to hold the fabric or substrate in place. Because of the porous nature of the fabric light-weight non-woven fabrics will not work with the UV printer 302 shown in FIG. 5. But with this feed system of the UV printer 302, light weight landscape fabrics can be used, for substrate 304. The substrate 304 may be woven fabric, however, non-woven fabrics will work too, which significantly reduces the material cost which creates a much more marketable and lower priced point product. An 8.0 oz. (ounce) fabric, for the substrate 304, will cost about 0.25 cents per square foot. Whereas a 4.0 oz. (ounce) non-woven landscape fabric, for the substrate 304, which is suitable for landscaping will cost approximately 0.11-13.0 cents per square foot. So these UV roll to roll printers, similar or identical to UV printer 302, that use the tension between the rollers 306 and 308. In at least one embodiment, roller 306 is not motorized but rather there are also internal “pincher rollers” that are located within the printer 302 as described above that also assist in feeding the substrate 304 through rather than the vacuum pressure on the belt feeds. FIG. 8 shows a hybrid belt feed printer 600. The printer 600 is typically large, the size of a truck, and allows for allow for lighter weight non-woven fabrics.

In at least one embodiment, the type of printer or printing process used for the landscape fabric is also important. Known prior art landscape fabric, that can be found at garden centers or on the retail market, typically are not suitable for roll-to-roll printing. In accordance with one or more embodiments of the present invention roll to roll printing has been determined to be the most cost effective and efficient way to produce large landscape fabric with correspondingly large landscape designs. However, in some embodiments of the present invention screen printing may be used.

The first challenge solved, in accordance with one or more embodiments of the present invention, is to provide consistent edges for the landscape fabric. Almost every large format roll to roll printer requires the print heads to clear the substrate when printing. This allows the print heads to clean themselves after every pass.

In at least one embodiment of the present application a woven polypropylene landscape fabric is provided. Generally, polypropylene, is the most commonly known used substrate for landscape fabrics.

Generally, in the prior art, most landscape fabric is heat cut which creates irregularities in the material's edges. These small, frayed irregularities, edges or sections stick up above the substrate. Unfortunately, expensive known roll to roll printers typically have “head strike sensors” so when there is something sticking up from the edges of the material; these roll-to-roll printers will shut down the print. If they do not have head strike sensors and the print heads hit the materials they can damage them. Print heads cost in the thousands of dollars to replace. Generally, when the roll-to-roll printer shuts down, it can not be restarted mid-way. If printing a forty-foot-long design and the print crashes thirty-five feet in, then the entire design is wasted and you need to start over. To print three hundred linear feet on an HP (Hewlett Packard) printer takes about 4.5 hours. Therefore, this can be a lot of wasted time and material when in full scale manufacturing.

The UV printers may allow the print to be restarted with a minor head strike. With a major head strike the prints will shut down and maintenance will need to be performed on the printer. Even with a minor head strike; having to reset the print and readjusted the material to fix the substrate that was stuck takes a lot of time and will be very labor intensive during a large manufacturing run.

In accordance with at least one embodiment of the present invention, for woven landscape fabrics, a process is provided where the material is produced to certain lengths by adjusting looms which actually manufacture and weave the woven landscape fabric into sheets, to produce set widths, rather than being cut down from larger rolls.

This adjustment of looms of the roll-to-roll print produces an initial fabric with a more consistent edge. This makes the fabric more expensive to produce as the efficiencies the manufacture gains from producing a wider initial sheet and then cutting it down are no longer applicable. This is why most landscape fabric is produced to much wider widths and then cut down.

To mass produce efficiently, most producers of known landscape fabric produce fabric up to fifteen or seventeen and one-half foot widths for width W3 for sheet 200 shown in FIG. 4, onto master rolls which could be several hundred meters long for length L1 shown in FIG. 4. Common widths, for W3 in FIG. 4, for known landscape fabric available on the retail market are much shorter for retail use. A common known landscape fabric on the retail market is usually three to eight feet wide and twenty to two hundred feet long. For known fabrics, fifteen or seventeen and one-half feet long fabrics are heat cut to shorter lengths, so that the ends do not fray as easily.

But there are also some known types of cuts that minimize the discrepancies in the edges, or there may be cuts (these are typically called these “selvedge edges”) that form a hem along the edge that makes the edges flatter.

In at least one embodiment of the present invention, known non-woven landscape fabric may be used. These fabrics non-woven varieties of poly propylene landscape fabric use different manufacturing technologies of polypropylene that have a more fabric like texture. Whereas the woven fabric relies on weaves between the strands to allow water and air to pass through, the non-woven fabrics can be needle punched and naturally allow for flow. These known non-woven fabrics are much more similar to a fabric than a plastic sheet. These non-woven landscape fabrics can also be produced at fifteen and seventh and one-half foot lengths.

When produced, a fifteen-foot section can be cut down to three, or five foot sections for the retail market. To do this, a fabric cutter, is typically used in the prior art. A fabric cutter provides clean cuts. However, the outer sections are typically folded over during the fabrics manufacturing process and when put through a printer do not lie flat. Generally, these master rolls typically require about three to six inches of the edges to be cut off. So when produced to a fifteen foot width, after trimming the edges, you no longer have three five foot sections. So the material needs to be manufactured to the 17.5 foot width which uses a large more expensive loom. The cost of producing master rolls from 15.0 to 17.5 feet is actually higher because the 17.5 foot wide master rolls require special tooling. But this is required if you want to have five-foot sections that are evenly cut on both sides. But there is also additional waste in doing so.

In accordance with one or more embodiments of the present invention, the inventor found that only the middle sections, such as section between line 202 and 204 shown in FIG. 4 with the professional cuts on both sides will print properly. The heat cut lines 202 and 204 mainly apply to woven landscape fabrics which are more of a plastic and fray when cutting. The non-woven landscape fabrics can be cut using industrial fabric cutters, which are also very expensive. With the non-woven landscape fabrics, a specialized fabric cutter that cuts rolls of fabric is utilized to cut the lines 202 and 204 to create the clean edge for lines 202 and 204. In order to have the manufacturer cut the ends off of the fabric rolls there are typically monetary charges not only for the wasted material and also monetary charges for the extra cuts. When the rolls of nonwoven landscape fabric come off the line the ends may be frayed. Generally, they may be a little frayed but also folded over on top of itself. In at least one embodiment, a perfect cut is desired so the sides of the rolls are flush in order to print properly onto the landscape fabric. When the material is folded like this it does not lie flat when feeding through the printer. When a specialized fabric cutter is used the ends of the roll of fabric are smoother. This is the type of cutter that is typically used to cut down the non-woven landscape fabric. But for a fifteen foot roll they only make two cuts in the middle to create three five foot sections for normal retail/commercial use. For our use case we need them to make four cuts. The two in the middle and to remove the ends which are folded over. Which is why a fifteen-foot width for W3 or is this L1 in FIG. 4 does not work and we need to get the 17.5 foot or somewhere in the middle. The five foot or 60.0-inch number we keep using is because this is the maximum print width for a lot of these printers, as shown in diagram 400 of FIG. 6. Most of these printers will print to 64.0 inches or 63.8 inches. These are in the mid-range in terms of price, but there are printed such as the HPR2000+ that can print to eight feet but are more expensive.

FIG. 6 shows a diagram 400 having a roll 402 of landscape fabric. The diagram 400 shows the roll 402 of nonwoven landscape fabric being cut to create three equal sixty inch sections. Generally, this is how non-woven landscape fabric is cut using fabric cutters. The outer edges of this type of material are folded over and not suitable for use in a printer. These ends which are not usually cut off in the normal use of the fabric need to be trimmed off to make the material eligible for printing.

In at least one embodiment of the present invention, the ends of the rolls for sections are trimmed off to produce a cleaner edge that will allow the material to lay flat in a printer, such as a roll-to-roll printer.

The inventor of the present application, found it difficult to very difficult to find a printer that could print white or any color on the black substrate for woven fabric.

After sending the woven fabric, such as fabric 200 shown in FIG. 4, out for testing on many different printers, the inventor found that the UV (ultraviolet) ink printers will print on the woven fabric substrate. UV ink is known to be fairly toxic, which is a problem for using the woven fabric as a weed block in a garden setting where the toxic ink may harm plants.

After a search, the inventor found a UV ink that is non toxic or less toxic. LUS170 is the ink that has been tested and was recommended by the distributor for printing on this type of fabric. The LUS170 is a Mimaki ink. Mimaki (trademarked) is a manufacturer that makes a UV ink that is non-toxic or at least less toxic that typical ink., LUS 170 made by Mimaki (trademarked) may be used for printing information including number designations for planting circles or regions on the fabric 200. This UV-curable ink cures and adheres to the fabric 200 by UV radiation. The UV-curable ink emits low levels of VOC (volatile organic compounds). LEDs used for the UV ink process do not radiate short wavelengths which are said to generate ozone.

The inventor then found the HP (Hewlett Packard) (trademarked) R1000 and R2000+ printers. These are latex printers and very advanced. These printers may have only come on the market a few years ago and have the ability to print white ink. White ink is important because while the landscape fabric, both woven and non-woven, can be produced to almost any color, black is the most readily available on the retail market. Purchasing other colors that are not commonly available requires very large orders of usually a truckload or more which can be upwards of 600,000 to 1,000,000 square feet.

White provides the most contrast when printing the landscape designs so the customer can more easily find the correct locations. Some latex printers are not able to print white ink on black material or white ink at all.

The HP (Hewlitt Packard) (trademarked) R1000 and R2000+ printers also have the ability to artificially adjust the printing head height to work better with the inconsistencies in the material. In at least one embodiment, printing at a head height of 0.15 inches or less is preferred. In addition to get the HP R1000 and R2000+ printers to print white on the black substrate a base layer typically needs to be applied first and then the white ink is applied on top of that.

The HP R1000 and R2000+ printers also have the ability to adjust the cure temperature for heat sensitive materials. When curing the light weight woven polypropylene landscape fabric at higher temperatures the fabric started to distort at a certain temperature. Polypropylene will melt at 163.8 degrees celsius but even prior to this temperature polypropylene starts to distort.

Only the HP latex printers were found to be capable of the above forementioned features. But each of the HP R1000 and R2000+ printers costs around two hundred thousand dollars and finding someone to test out the material on these printers is extremely difficult.

After testing, the inventor found that either of the HP R1000 and the R2000+ printers would print on the fabric, but for a large production run the inventor had to adjust the specifications of the fabric to make it suitable for printing/mass production. In at least one embodiment of the present application, to adjust the fabric the weight of the fabric (woven PP fabric 200, shown in FIG. 4) is increased from 3.5 ounces. The weight, such as 3.5 ounce example can be found available in retail stores anywhere from three feet wide to eight feet wide plus, and is commonly one hundred feet and under in length. Five ounces is not commonly found on the retail market in non-woven fabric, but rather 3.5 ounces is pretty much the industry standard. In at least one embodiment of the present invention the looms adjust the manufactured width to five feet (max print width of the HP R1000 printers). These rolls also had to be cut down into two hundred foot rolls (but can support larger) to make sure the rolls do not exceed both the weight of materials the printer can hold as well as the diameter of the roll these printers can hold. Generally, tabletop rollers such as rollers 612 and 616, shown in FIG. 8 can support 44.0 pounds. A two hundred foot roll is under forty-four pounds. The max weight is forty-four pounds for a two hundred foot length L1, roll of fabric 200, shown in FIG. 4. The max weight on the infeed for the HP R1000 printer is seventy-seven pounds and the max roll diameter is 9.8 feet.

For the HP R1000 and R2000+ printers, for printing on the PP (polypropylene) fabric 200 shown in FIG. 4, the printheads may be universal optimizer. The ink cartridges used for printing are typically white. Generally, in at least one embodiment, these HP printers will only use the HP latex inks or the warranties may be voided. The roll weight limit maximum for the R1000 is one hundred and fifty pounds and for the R2000 it is two hundred and twenty pounds.

In accordance with one embodiment of the present invention, the settings for either the R1000 printer or the R2000 printer had to be adjusted. There is a specific print profile for this material which is a mix of print settings, and heat settings, which in at least one embodiment, of the present invention are as follows:
Name Five Pass spot white
Color Mode—Six colors plus white
Printing Method—White Spot
Heat Sensitive substrate-no for 8.0 oz yes for 3.0 oz
Number of pass: Five
White density 60%
Ink Density 60%
Ink Density B n/a
Over coat level 0.5
Curing Temp 149 degrees Fahrenheit
Advanced Settings:
Dry temp 175*Fahrenheit.
Latex optimum level: 18%.
Substrate advance: 0 (inch)
interpass delay offset: 0 (ms) milliseconds.
Printing airflow pressure: 40.0 (pa)
Curing air flow pressure: 430.0 (pa) (pascals)
Curing height inches: 0.98
Carriage height offset. 1 to. 15 inches

The HP R1000 and R2000+ printers are belt fed. This requires the substrate to be vacuum sealed down to the bed during the printing, so it does not slip. In at least one embodiment, the hybrid UV printers are the same in this regard.

The inventor started using a lighter weight woven landscape fabric (which has better filtration properties), what has a weight of 3.5 ounces. However, when being fed through the HP R1000 or HP R2000+ printer, because the fabric was so light weight, the fabric started to bubble. The standard weight of woven landscape fabric is about 3.5 oz. Even with the vacuum pressure at maximum, either of printer HP R1000 or HP R2000+ would cause the substrate to bubble up and these bubbles would then cause head strike sensors to shut down the prints.

The inventor then had to manually adjust the head height of the HP R1000 or HP 2000+ printer to an insert head height to 0.22 to 1.5 inches depending on the quality of the individual roll. In addition to manually adjusting the head height, once the printer head height was adjusted an additional manual printer head height alignment needs to be run, for a cleaner print, but doesn't necessarily have to be, if the print does not need to be very clean.

However, the inventor found that the best way to print on this woven landscape fabric was to increase the weight of the fabric to five to six ounces, or more. The five to six ounce or more weight makes the fabric a bit more rigid which produces less “bubbles” but when increasing the weight on the material you significantly decrease its permeability. So the higher the weight the worse the woven landscape fabric was for landscaping as it would not pass water easily. However, the lighter weight 3.5 ounce per square yard fabric would work on the UV roll to roll printers. The weight of the fabric is typically measured in ounces per square yard.

The only way to get the type of edges needed and the weight needed, wherein the weight is not commonly produced for landscape fabric, the inventor had to order 400,000 square feet of material with weight between five and six ounces. In order to get any manufacturer to produce this uncommon weight this was the minimum order quantity (400,000 square feet). The manufacturer would not produce this weight without a big order as to do so they needed to adjust their looms to produce the heavier material which takes quite a bit of setup and uses more material.

The HP R1000 and the HP R2000+ printers have a maximum substrate weight that they can hold for fabrics applied to their factory in feeds. Therefore, the inventor had the-woven fabric produced to the higher weight, manufactured to a five-foot width (largest width these printers could handle), and spun onto two hundred-foot rolls with three-inch diameter cores. This is the core size that almost all of the applicable printers use. Most manufacturers of the landscape fabric for longer length rolls are four or more inches in diameter. As these rolls are typically used on agricultural equipment for us in farming. Three inch cores are not commonly used and also requires a special order to get the manufacturer to produce the material onto the smaller core diameters. The inventor uses the higher weight, with consistent edges, and the HP print Profile, on three-inch cores for the infeed.

However, in at least one embodiment, two hundred-foot rolls of woven fabric are re-spun off of a “Master Roll” which comes directly off the loom, wherein loom refers to the manufacturing of the landscape fabric. The landscape fabric is produced on a loom, a “loom” is not part of either an HP R1000 or an HP 2000+ printer.

When these rolls of fabric are re-spun one side was found to be tensioned more than the other, as known in the art, although different manufacturers may re spin rolls of fabric differently. This woven fabric is a bit elastic, so when the woven fabric is re-spun onto the smaller cores, one side stretched more than the other. In accordance with one embodiment of the present invention the fabric, such as fabric 200 on a roll, is unrolled to make sure it is evenly tensioned.

In at least one embodiment, the inventor unrolled a full two hundred foot roll and found out that the woven fabric is stretched and starts to curve. This causes a number of problems for the printers as the woven fabric starts to shift and does not feed straight through the printers. This can cause the material to bunch up and jam the printer, as well as distort the images and distances between the printed graphics which are a critical part of the design.

At first, in order to correct this, the inventor had to have someone constantly manually adjusting the rolls on the printer as one side would start to bunch up.

The master rolls are too heavy for the printers. However, the inventor ordered the end of one of the master rolls (from China) and found this printed much better and did not have the same “stretch” to one side. The “stretch” to one side occurs when the smaller rolls are rolled off of the master rolls.

So to use this woven fabric material the only way to make them suitable for large production runs would be to either use the master rolls and an aftermarket attachment that could handle the weight. In at least one embodiment, a roller on one side that feeds into the printer may be used. But to tension the rolls it would have to also connect to the printer to feed at the same rate, but could also be free standing allowing the tensioner from the outfeed to pull it through, if it is strong enough. Or have the looms shut down early to produce rolls that weigh under the max weight of the infeed or tabletop feeder of the HP Printers or any printer as the roll-to-roll attachments that come standard all have max allowable weights. Having the looms shut down early to produce the rolls this way was more expensive.

In at least one embodiment, the inventor then tried to use non-woven landscape fabrics but because of the way they are produced they are very permeable and the suction on the print beds of the HP roll to roll printers (R1000 and/or R2000+) had a hard time holding it in place. This led to the fabric drifting on the print bed during the printing process which distorts the image and placement of the circles which are the most critical part of design to be printed on fabric in accordance with an embodiment of the present invention. All of the circles are placed in exact measurements to represent the mature spread of the plants. If the circles and center lines are off the plants will grow to maturity and may cause overcrowding in the planting bed. This can lead to plant death, require additional maintenance to prune back, and unappealing aesthetics of the mature planting. This happens years after the plants are installed so getting it right the first time is very important. If a plant is not spaced properly it may need to be removed and relocated if possible or a new plant installed in its place. This is very important as to why these printing methods need to be absolutely perfect, if possible, in at least one embodiment.

In at least one embodiment of the present invention, the inventor started using an eight-ounce non-woven landscape fabric and found that when cut properly (middle sections, or with the edges fabric cut) these non-woven fabrics would suction down in a hybrid printer allowing them to be used.

In the prior art for landscaping purposes, it is generally known to use non-woven fabrics anywhere from two to eight plus ounces for a variety of different purposes. The heavier the weight the longer it lasts. But typically eight ounce fabrics are used for very large construction projects, such as highways, as they last for a very long time and are more suitable to prevent erosion. So eight ounce fabrics are typically used as erosion control blankets and not as commonly used for plantings. The eight-ounce fabric is suitable for landscaping purposes but is a higher weight than is needed for most landscaping purposes. Eight-ounce fabric is much more expensive. For landscaping applications three to five ounces is suitable for weed suppression.

However, when using the eight-ounce non-woven landscape fabric, the HP printer R1000 and/or R2000+ can be table top fed or fed to the factory infeed to outfeed works. In at least one embodiment, of the present invention, enough non-woven fabric needs to be passed through before printing so we can attach it to the factory outfeed roller. By adjusting the tension, such as preferably in accordance with at least one embodiment of the present invention, through a computer on a printer. The infeed and outfeed roll at the same time and the tensions can be adjusted on the HP printer R1000 or the HP printer R2000+ so one side pulls a little more than the other so it feeds through better. Using the highest vacuum setting on the HP R1000 and/or HP 2000+ printer we are able to get the eight-ounce non-woven fabric to print, while also using the HP print profile setting for this material, which was referred to previously.

When using the factory infeed and outfeed rollers, with tensions on the rollers adjusted as needed, a properly scaled print is possible on the non-woven fabric.

Generally, white just happens to be the slowest printing color as it's a difficult color for Latex printing as this also requires the subbase to be applied prior to the white ink, however white is preferred because landscape fabric is typically colored black so that it is difficult to see, blends in, and/or is camouflaged beneath plantings in an outdoor setting.

The UV printing, with the non-toxic ink or less toxic ink in this example, a Mimaki (trademarked) UV ink was tested by the inventor on a roll-to-roll printer, and the ink adhesion was good and using the UV light rather than the heat curing there are no problems with the non-woven fabric being heat sensitive. A Mimaki (trademarked) UV printer, may be used but there are a variety of different UV printers available that can do the same. The type of ink of non-toxic or less toxic ink that can be used is the LUS-170 and here is the link https://mimaki.com/supply/ink/uv-curable.html)

The negatives are UV ink is much more toxic in liquid state compared to the Latex printers which are water based, but which require heat to cure the ink. HP latex ink boasts the most environmentally friendly inks on the market currently.

The UV inks such as LUS-170 provide better ink adhesion to the woven and non-woven fabrics. LUS-170 ink is a newer type of UV (ultra-violet) ink design by Mimaki (trademarked) and is represented as a more ecologically friendly or less toxic option of UV inks. In at least one embodiment, LUS-170 ink is used because many standard UV inks when cured can be rigid and brittle. LUS170 ink was specifically designed for flexible media to be more flexible so the designs and graphics do not crack which can effect the functionality of the print when not properly displayed or readable.

The benefit to these roll-to-roll UV printers are that the curing temperature is a non-factor and the roll to roll UV printers use the tension between the two rollers 306 and 308, as shown in FIG. 5 to feed the woven or non-woven fabric 304 through and print. This differs from the hybrid roll-to-roll HP printers R1000 and R2000+ which require a vacuum bed. So using a UV roll to roll printer, such as printer 302 we can decrease the weight (and cost) of the substrate and produce a better quality print. UV roll to roll printers are also much cheaper such as the Mimaki (trademarked) Ucjv300-160. The UCjv300-160 is the cheaper printer. This printer is a roll-to-roll printer and is much cheaper than a hybrid printer such as the HP1000+ or a hybrid UV Printer.

The inventor has determined that these roll-to-roll printers, such as printer 302 in FIG. 5, that use tension to pass the material through the printer are not as advanced as the HPr1000 and HpR2000 printers, or the more expensive UV hybrid printers which have higher adjustable head height settings. The HPr1000 and HPr2000 printers are hybrid printers. The standard roll to roll printer, may be a printer, such as the Mimaki UCJV300 Mimaki printer. The hybrid printers can also print on rigid media which typically has a thicker substrate thickness for billboards. The hybrid printers can print on larger media above 1.0 mm in thickness. The standard roll to roll UV printers typically can only print on media with a thickness of 1.0 mm or under. UV printers in this class that can print on substrates having a thickness over 1.0 mm are asserted not to be known. There are hybrid UV printers which can print on material with a thickness of over 1.0 mm. These printers are similar to the HPr1000 and HPr2000 but use UV ink whereas the HPr series printers (such as HPr1000 and HPr2000 use Latex. Generally, UV printers, and other similar in class printers, are listed at one mm or less, in terms of the thickness of the substrate 304 that they can print on. Therefore, when we the 8.0 oz. landscape fabric was tested, the print heads were scraping the top of the material and the fibers were getting jammed up in the print heads. The raised fibers above the non-woven landscape fabrics are also known as “napp”. That means that the 8.0 oz (ounce) material that is required to work on the HP printers for the suction beds is too thick to pass through the non-hybrid UV printers. The thickness of the 8.0 oz. non-woven is approximately 1.143 mm which would not pass through the UCJv300-160.

The 4.0 oz fabric that has a thickness of 0.889 mm has been tested. However, this is the thickness of the substrate and due to the fibrous nature of this non-woven material there are still small strands (napp) that stick up higher which may be get tangled into the print head, which cost thousands of dollars to replace, but for the purpose of this application the 3.0-4.0 oz thickness is suitable for the UV printer 302 for use in embodiments of the present invention.

Because printing was never an intended purpose for this material, thickness is not a unit of measure typically associated with the manufacturing process of this material. Therefore, there are still some variations in the exact thickness.

In at least one embodiment, screen printing may be used for both the woven and non-woven fabrics. It is not as efficient as roll-to-roll printing but uses different inks that work very well. Because screen printers use screens to print and not ink cartridges and print heads, many of the problems printing on this woven and non-woven fabrics go away.

In order to screen print the designs on either the woven or non-woven fabrics, custom screens need to be cut. Then the substrate is placed on a flatbed screen printer, and the ink is applied over the screens to form the designs.

The largest commercial flatbed screen printer that the inventor has been able to find commercially available is only four feet wide by ten feet long. Once the screens are created, one can mass produce these designs on woven or non-woven fabrics. But the setup is more expensive than roll-to-roll printers, as one needs to create a new cut screen for every layout. And at only four feet wide by ten feet long, one is limited to only smaller sections, or multiple screens and smaller sections which need to be connected together when planting.

The roll-to-roll printers can print up to ten feet wide (some even wider) and hundreds of feet long. This makes it much easier to produce larger more complex designs and to print to order.

In at least one embodiment of the present application, biodegradable paper mulch may be used instead of woven or non-woven fabric.

The biodegradable paper mulch will work with UV printers, Latex Printers, and Screen printing. Bio-Degradable paper mulch is similar in form to heavy-duty construction paper and can be printed on. Because it is bio-degradable, the inventor was hesitant to use it as the ink will degrade into the soil. However, in at least one embodiment of the present invention, customers will be instructed to completely remove the printed section before planting.

Using the biodegradable mulch and screen printing, in accordance with one embodiment of the present invention, water soluble inks can be used. One water soluble ink that may be used is called “AquaSoft” (trademarked) white ink. Different types of water-soluble screen-printing inks can be used. This also allows for the use of non-toxic and/or less toxic agricultural dyes, but these dyes need to be adjusted to work with screen printing. In at least one embodiment of the present invention, the viscosity of the agricultural dyes has to be adjusted for screen printing, to a level of between 6,000-10,000+ centipoises, to work with these industrial large format screen printers the ink needs to be thick enough to pump through the applicators and the viscosity needs to be high enough so the ink does not bleed onto the surrounding substrate and will stay where the cut out on the screen is to form the desired graphic.

In addition to the water soluble ink, if possible it is desired to provide screen printing solutions that are carbon negative and generally better for the environment. These are the Algae Inks from Living Ink (trademarked) and the inventor found a Carbon based ink that's is actually made from carbon capture. https://www.graviky.com/or vegetable natural based inks.

To summarize, in one or more embodiments of the present invention, the landscape template may be printed on woven or non-woven polypropylene landscape fabric as well as on biodegradable paper mulch.

In at least one embodiment, to be suitable for roll-to-roll printing the fabrics must be produced in such a way that the edges are flat and consistent. This is the most crucial factor for all roll-to-roll printing.

To work on an HP latex printer, such as model number R1000+ and R2000+, the fabric has to be a higher fabric weight for both the woven and non-woven, such as over 3.5 ounces for woven, and more than two ounces for non-woven, so that the fabric feeds through the appropriate printer properly.

The correct white ink spot settings, vacuum pressure settings, infeed/outfeed tensions settings, and curing temperature need to be adjusted to specification, such as for example, give range or exact setting examples for different versions.

The printer head height also needs to be manually adjusted (higher) and calibrated upon adjustment. High enough to prevent shutdowns, but low enough to produce a good image.

UV printing requires most of the same setup with the exception of the heat settings. The inks produce a better image but are more toxic in liquid form. UV printing using a standard roll to roll uv printer also requires that the substrate be manufactured so that the thickness of the substrate does not exceed 1 mm. In the use case of non-woven landscape fabric the substrate will produce in manner wherein the substrate itself and the fibers (napp) that stick off the substrate do not exceed 1 mm. Unless a hybrid UV printer is utilized which is very similar to the requirements of the HPR1000 and R2000+ printers. Screen printing is possible but requires more setup and is more limiting.

FIG. 8 shows a simplified diagram of a hybrid printer 600 with suction bed for use in accordance with an embodiment of the present invention.

The hybrid printer 600 shown in FIG. 8 is known in the art, and includes an infeed table top roller 602 which can be used for rolls of fabric with a roller attachment or for rigid media. In FIG. 8, the flat sections 602 and 608 support rigid media and flexible substrates. “Rigid media” as defined in the present application, typically includes cardboard billboards, metal sheets, and any non flexible substrate. “Flexible” substrates, as defined in the present application, typically includes vinyl for banners, paper composites, and other plastic based substrates used for signage.

The hybrid printer 600 further includes a suction bed or beds 604 and 606, which starts right after the tabletop roller 602 and continues through the printer where the printer heads pass over the substrate or fabric 610.

The hybrid printer 600 includes a detachable or fixed area 608 for rigid media such as signs.

The hybrid printer 600 is shown processing a substrate 610, which may be a landscape fabric, non-woven or woven, or a paper mulch, such as a biodegradable paper mulch.

The hybrid printer 600 also includes an infeed roller 612 but does not rely on this as much to pass the material (fabric) through the printer 600.

The hybrid printer 600 further includes a main printer module 614 with print heads inside, and a heat curing module inside which has settings which are adjusted if needed for sensitive material.

The hybrid printer 600 includes an outfeed roller 616, but the hybrid printer does not typically rely on this as much. However, the tension setting of the outfeed roller 616 is typically adjusted to get the outfeed roller 616 to pull the material (fabric) more flat which creates better suction on the bed.

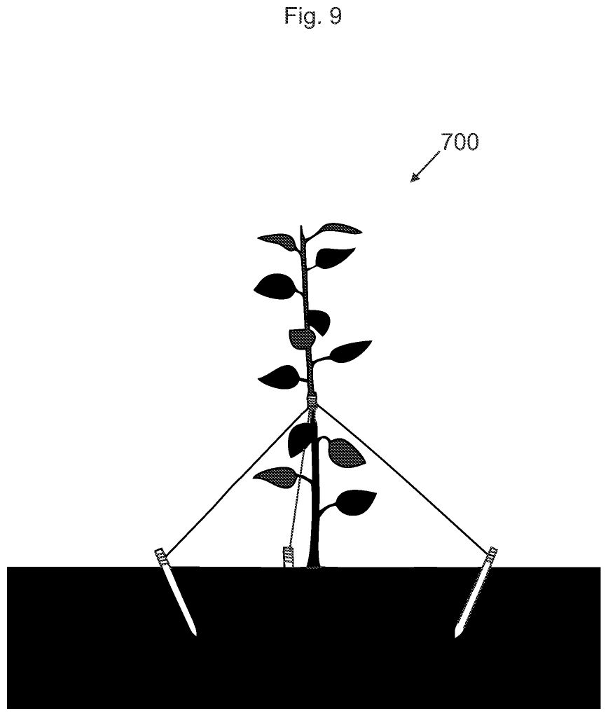

FIG. 9 shows a simplified diagram 700 of a tree tied to a plurality of stakes.

FIG. 10 shows a simplified diagram of an online interface or internet web page 800 with associated plant information. The online interface may be displayed on a computer display 1204 of computer apparatus 1200 in accordance with computer programming stored in computer memory 1210, and as implemented by computer processor 1206. The computer processor 1206 may communicated with computer display 1204, computer interactive device 1202 (such as a computer keyboard, computer mouse, and/or computer touchscreen, the computer memory 1210, and a computer input/output port 1208 via communications links, such as hardwired, wireless links or any other known communications links.

The interface 800 includes field 802 which shows a title “My Designs” and refers to field 804 which is a type of landscape design called “Sunshine Daydream”. The interface 800 includes a photograph 810 of the landscape design after it has been implemented. The interface 800 also includes fields 808, 812, 814, 816, 818, each having a circle region above a word title, wherein the circle or corresponding word can be clicked on using the computer interactive device 1202 to pull up a menu corresponding to the word title. For example, the circles for fields 808, 812, 814, 816, and 818, can be clicked on to pull up and display on the computer display 1204, a garden assistant, an orders page, an addresses page, a profile page, and a logout page, respectively, for a single user. Each user would have their own custom dashboard, such as including interface 800.

The interface 800 also includes a field 806 which provides instructions and some warning information, as shown by the exclamation point within a triangle.

The interface 800 also includes a field 820, into which can be entered a “planted on date”, In at least one embodiment, the “planted on date” is used to provide tailored instructions through the interface 800 based on the specific design's care needs. A field 822 is also provided, through which a hardiness zone for plants can be entered through a pull-down menu. The interface 800 also includes a save button or field 824 for saving data entered in the interface 800 by a user in the computer memory 1210 as programmed by computer software in the computer memory 1210 and executed by the computer processor 1206.

The interface 800 also includes a plant info field 826, a shopping list field 828, instructions field 830, and a custom design field 832, each of which can be clicked on to enter appropriate information. For example, here a user can make substitutions of plants within a design and enter new plant information to update the computer output care information for the design. As an example, if the design calls for the Russian Sage (as depicted) but the customer wants to switch this plant they can edit the plant field by selecting the edit button or field 854 using computer interactive device 1202, which allows the user to switch the plant name shown to the right of “name” 840, through computer software stored in computer memory 1210 as implemented by computer processor 1206. The interface 800 also includes a “plant info” title 836, a blueprint title 828 next to the number “1” indicating one blueprint; a name field 840 next to the terms “Russian Sage-Perovski Atriplicifolia” corresponding to the name of a plant; a quantity field 842 next to “1” indicating a quantity of “1”; a USDA (US department of agriculture Zone) next to 4a-9b indicating type of hardiness zones this plant should be in; an “Average Width (inches)” field 846 next to the number “48” indicating 48.0 inches for average width of this plant at maturity; a “Light Needs” field 848 next to “Partial Sun” indicating how much sun this plant needs; a “Water Needs” field 850 next to a word “Low” indicating the water needs for this plant are “Low”, and a “Water Needs at Maturity” field 852 next to explanation of water needs in this case as “Once establish, water occasionally, more in extreme heat or containers”. The interface 800 further includes a “Care” field 856 having explanation for care of the particular plant, i.e. hear the “Russian Sage”. There is also a “chat with us” button 858 provided. There is also an “Edit” button 854 provided which can be used to edit the terms to the right of the fields 838, 840, 842, 844, 846, 848, 850, and 850.

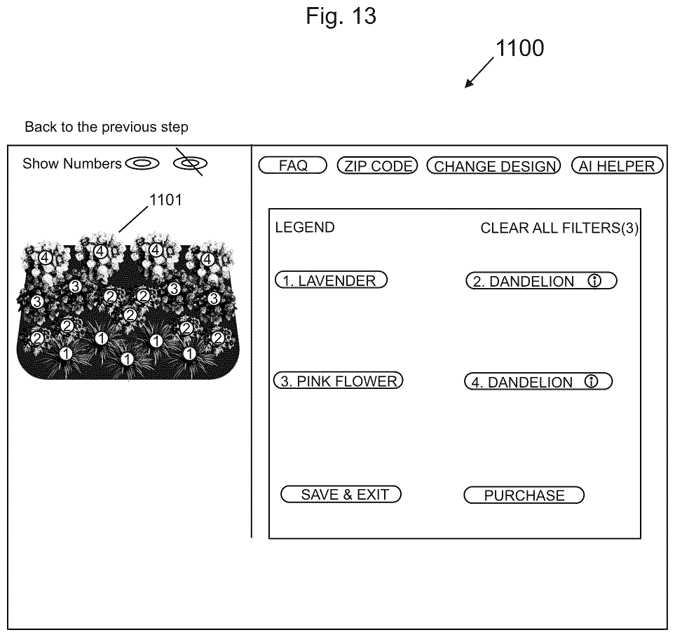

FIG. 13 shows an internet web application or software application interface 1100 to assign plants with visuals. The interface 1100 may be displayed on computer display 1204 by computer processor 1206 in accordance with computer software stored in computer memory 1210.

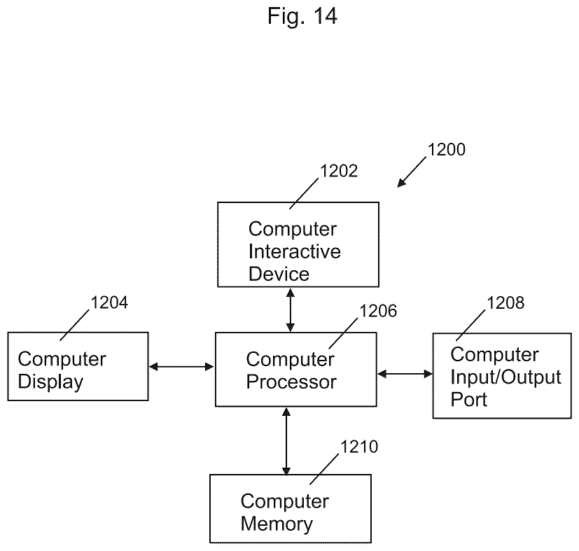

The interface 1100 provides fields or buttons for “FAQ” “ZIP CODE”, “CHANGE DESIGN”, and “AI HELPER”, which can be selected or clicked on using computer interactive device 1202 of FIG. 14. When “FAQ” button is selected, frequently asked questions are programmed by computer software stored in computer memory 1210 to appear on the computer display 1204 as implemented by computer processor 1206. When “ZIP CODE” button is selected, using computer interactive device 1202, the zipcode button will change the landscape plans available to the customer. These plans are represented by “1” Lavender, “2” Dandelion, “3” Pink Flower which can be selected to customize a location of the planting. The zip codes are tied to a CSV (Comma-Separated Values, this is a type of table or data association so in this case a USDA hardiness zone is associated to a long list of zipcodes). So when a zipcode is entered the computer knows which hardiness zone the customer is in. on the website which connects them to a specific USDA (US Department Agriculture) hardiness zone. The customer will then only be able to select from plants that are viable for their climate and growing zone so they do not choose a plant that will not survive When “CHANGE DESIGN” button is selected the computer display 1204, will be switched to a different layout with different asethetics and plant requirements as well as sizes of the designs as a result of computer software stored in computer memory 1210, implemented by the computer processor 1206. The “AI HELPER” button is an Al chatbot the customer can ask questions to about the plant designs and other aspects of horticulture. Open Al may be used for this feature and specific plug ins may be utilized to train the chat bots on the designs.

The interface 1100 also shows buttons for “1. LAVENDER”, “2. DANDELION”, “3. PINK FLOWER”, “4. DANDELION”. These buttons can be selected to change the design shown in the photograph 1101. If 1. Lavender is selected the plants in the graphic preview will change to lavender plants and that plant will be added into their design file as shown in the user dashboard Basically just substitutes the plant that is currently in the design file.

The interface 1100 also includes a photograph 1101, which is shown in black and white, but which would typically be in color when displayed on the computer display 1204. The photograph 1101 shows a plurality of plants, which have a number over them to identify them. For example there are four number “4”'s shown in a corresponding four circles over four corresponding images of plants, respectively, near the top on photograph 1101, to identify four dandelion plants. There is also four number “3”'s in four corresponding circles over four corresponding images of plants in the photograph 1101 to identify pink flower plants. There are also seven number “2”s in a seven corresponding circles over seven corresponding images of plants to identify dandelion plants. There are also five number “1”s in five corresponding circles over five corresponding images of plants to identify lavender plants. Correct Not sure if we need to tie this into the printing process. But those graphic numbers representations in this interface will correlate to the printed designs on the landscape fabric FIG. 2, or separate pdf templates as shown in FIG. 1.

In at least one embodiment, a customer may select a location on the map 900 or 902 in FIG. 11 based on the numbered location and can then select the plant from the legend in FIG. 13, such as “Lavender” to change what plant is in that number “1” position, such as in planting circle with “1” in it in outline 902a in FIG. 11. The interface 1100 also includes “SAVE&EXIT” button and “PURCHASE” button which are configured to be selected to allow a customer to come back to the design to continue where they have left off. These designs will be saved and/or accessible using section 802 “my designs” in FIG. 10. Purchase button in FIG. 13 allows the customer to buy the design, such as the design 900 or 902 shown in FIG. 11, either in a digital format without the large printed fabric or with the large printed fabric with the option to buy the plants selected via ecommerce as well.

The interface 1100 also shows wording for “Back to the previous step” which is configured to be selected to go back and change the layout and design that was selected, such as the layout and design 900 or 902 shown in FIG. 11. The interface 1100 also shows wording for “Show Numbers and a symbol with two ellipses and another symbol with a line through two elipses. This will display the numbers over the display of the individual flower such as shown by circles with indica of “4”, “3”, “2”, and “1” within circles over photograph 1101.

When a particular number is selected and a new plant is chosen from the legend of FIG. 13, all four of those plants, numbered “1”, “2”, “3”, and “4” in photograph 1101 of FIG. 13, will change on the computer display 1204 and in computer memory 1210 as implemented by computer software stored in the computer memory 1210 and implemented by computer processor 1206. This is done to keep the design true to how it was created. Using landscape design principles, the base layouts are created and plants may be repeated to create harmony based on a number of basic landscape design principles. These locations may or may not also include additional attributes outside of the mature spread of the design (this is what most companies do).

So if number “1. Lavender” is selected from the Legend of FIG. 13, then Lavender becomes the plant assigned to that location and the graphic representation changes and all of the associated plant information is updated in the user dashboard for that design.

In at least one embodiment of the present invention, additional metrics to each location may be applied, such as the type of plant aka shrubs, grass, perennial, the season in which it blooms, the mature maximum or minimum height of the plant (so the design is layered which is a landscape design principle so one plant does not cover the other).

In at least one embodiment of the present invention the planting sections, or planting circles for example, can also be selected to match contrasting and complimenting colors of the plants which then filters the plants in the legend the customer is able to choose from.

The interface 1100 also shows a photograph of a four plants of a landscape design, which includes hydrangeas, perennials, shrubs, and grasses.

FIG. 14 shows the computer apparatus 1200 for use in accordance with an embodiment of the present invention.

FIG. 11 shows a simplified plant card 900 associated to the printed landscape fabric layout maps. The simplified plant card 900 may be printed on paper. The simplified plant card 900 may include a planting diagram or outline 902 with planting circles shown printed thereon. The planting circles may include one circle having the number “1” printed within the circle, two circles having the number “2” printed within each circle, one circle having the number “3” printed within the circle, one circle having the number “4” printed within the circle, three circles having the number “5” printed within the circle, and one circle having the number “6” printed within the circle.

The simplified plant card 900 may also include a table 904 printed on the card 900. The table 904 may have headings “Number”, “Width (Min-Max)”, “Height (Min.-Max)”, “Select Your Plant”, and “Qty” (which is an abbreviation meaning quantity), in the first, second, third, fourth, and fifth columns of the first row, respectively. Underneath the “Number” heading is a number corresponding to a number within the planting outline 902. Underneath the “Width (Min-Max)” heading is a range of widths for the particular “number” of plant in the particular row. Underneath the “Height (Min-Max)” heading is a range of heights for the particular “number” of plant in the particular row. Underneath the “Select your Plant” heading is for when a customer goes into a store and decides to choose their own plants. Attributes are provided for each location and customers can find plants in store or online that meet these specifications. So, the locations may only not identify specific plants but a plurality of requirements for that location; and the customer then fills in the plant name.

In at least one embodiment, the table 904 may include a column for “Plant Type”, and this would typically show either “shrub”, “grass”, or perennial”. The information for “Plant type” may be automatically provided and displayed on computer display 1204 by computer program stored in computer memory 1210, implemented by computer processor 1202, in response to a customer entering a plant name in “select your plant”. For example, if a customer enters a plant name in row “1” then the “plant type” may automatically display “shrub”, “grass”, or “perennial in row “1” corresponding to that plant.

Underneath the “Qty” is the number of plants of the “number” type needed for this particular planting outline 902 for the particular row. For example, two number “2” type plants are needed for this particular planting outline or diagram 902. I.e. the row with the “Number” “2”, corresponding to the planting circles “2” in outline 902, indicate “2” plants of number “2” type are needed as shown by the two planting circles in outline 902.

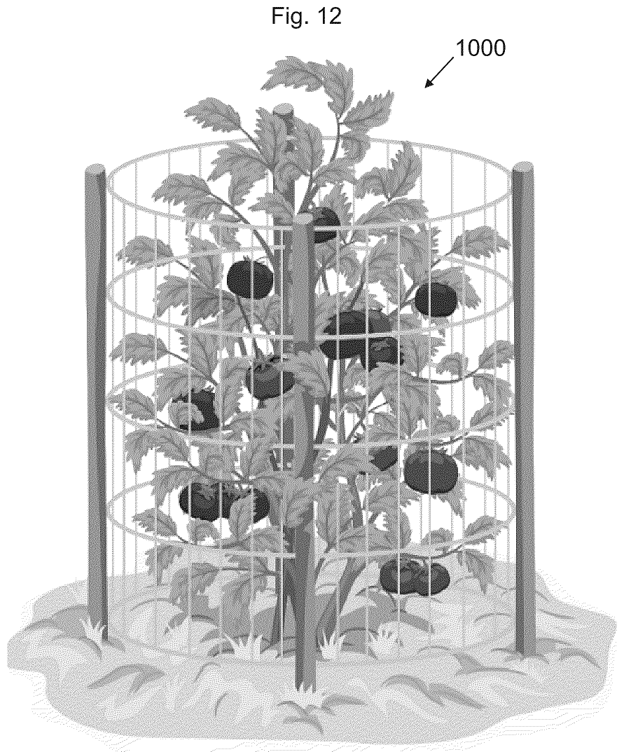

FIG. 12 shows a diagram 1000 of a tomato plant within a cage.

In at least one embodiment of the present invention, generally roll to roll printers, may be used or hybrid printers to print on landscape fabric. A so called “hybrid printer” in accordance with embodiments of the present invention, is a printer that allows for both rigid media and flexible media.

Generally, UV (ultraviolet light) and/or latex printers are roll-to-roll printers. However, there are also UV hybrid printers and latex hybrid printers.

Suction beds are provided in hybrid printers but may not be provided in all roll-to-roll printers (which are not hybrids) to hold down rigid media. However, generally hybrid printers are “hybrids” because they also allow for roll-to-roll printing.

Generally, most roll-to-roll printers require media to be one millimeter or less in thickness.

Generally, in one or more embodiments, there are other types of ecologically solvent roll to roll printers, fabric sublimation printers, and other digital roll to roll printers which could be used for printing on landscape fabric.

FIG. 13, shows numbered locations “1” for Lavender, “2” for Dandelion, “3” for Pink Flower, and “4” for “Dandelion, which are defined by all of the attributes for a plant that should be placed in that location, which correspond to we will probably need to insert a number over one of the plants possibly the four plants in the back row.

In at least one embodiment, the present invention uses printers which were not used in the prior art to print on landscape fabric type of material and a landscape fabric material that was not used in the prior art to be printed on.

In at least one embodiment of the present invention, characteristics of landscape fabric material are adjusted to work on a plurality of roll-to-roll printers.

In at least one embodiment of the present invention, the settings of printers are adjusted to work on a plurality of landscape fabrics.

In at least one embodiment of the present invention, planting indicia is printed on bio-degradeable paper mulch.

In at least one embodiment of the present invention, biodegradeable paper mulch is used, and the indicia is printed with a non-toxic or less toxic ink.

In at least one embodiment of the present invention, alphanumeric location identifiers, such as number indications within planting circles, such as “1” in diagram 900 or 902, are of a size, such as three inches, that is easily readable, but that is small enough to be completely removed.

In at least one embodiment, it is preferred that a non-woven landscape fabric is used on a UV (ultraviolet light) roll-to-roll printer to print indicia for landscaping, such as the indicia for planting circles, the numbers within the planting circles, and the outline for a planting bed 15f shown in FIG. 3A. In at least one embodiment, it is preferred that the non-woven landscape fabric has the proper cuts, as disclosed previously in this application, or is produced in such a manner that the thickness of the non-woven landscape fabric is under one millimeter and the edges of the landscape fabric after cutting are flat and uniform.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
printing indicia on landscape fabric using a roll-to-roll printer; and
wherein the landscape fabric is configured to have a plurality of characteristics based on the printing requirements of the roll-to-roll printer.

2. The method of claim 1 wherein the roll-to-roll printer is a hybrid printer, which uses a suction bed to configured to suction the landscape fabric; and
wherein the hybrid printer is configured to print on box flexible media and rigid media.

3. The method of claim 1 wherein
the plurality of characteristics of the landscape fabric include a weight per square foot of the landscape fabric;
and wherein the weight per square foot of the landscape fabric is great enough to hold the landscape fabric in place by the roll-to-roll printer.

4. The method of claim 1
wherein the plurality of characteristics of the landscape fabric include that the landscape fabric has been cut from a sheet which is larger than the landscape fabric in a manner so that at least one edge of the landscape fabric is uniform.

5. The method of claim 1 wherein
wherein the plurality of characteristics of the landscape fabric include that the landscape fabric has been hemmed from a sheet which is larger than the landscape fabric in a manner so that at least one edge of the landscape fabric is uniform.

6. The method of claim 1
wherein the plurality of characteristics of the landscape fabric include a thickness, which includes a plurality of fibers that are part of the landscape fabric, and wherein the thickness of the landscape fabric is one millimeter or less.

7. The method of claim 1 wherein
the landscape fabric is a non-woven landscape fabric.

8. The method of claim 1 wherein
The landscape fabric is a woven landscape fabric.

9. A method comprising the steps of:
printing indicia on landscape fabric;
wherein the landscape fabric is biodegradable paper; and
wherein the indicia is printed using ink made of algae.

10. A method comprising the steps of:
adjusting the viscosity of an agricultural dye to form a modified agricultural dye having a viscosity of between 6,000 and 10,000 centipoises;
printing indicia on landscape fabric using ink made of the modified agricultural dye; and
wherein the landscape fabric is biodegradable paper.

11. The method of claim 1 wherein
the indicia show one or more closed shapes, with an alphanumeric character within each of the one or more close shapes, and
further comprising providing further information matching up each alphanumeric character with a particular plant.

12. The method of claim 11 wherein
the further information matches up each alphanumeric character with at least one material that is used with the particular plant for planting the particular plant.

13. The method of claim 11 wherein
the one or more closed shapes identifies planting location and wherein an additional landscaping requirement is provided on a card for each planting location of each of the one or more closed shapes.

14. The method of claim 1 wherein
the printing indicia includes a closed curve planting bed outline.

15. The method of claim 1 wherein
the landscape fabric is comprised of two sections which are configured to overlap to cause the printing indicia to define a closed curved planting bed outline.
